(19) United States
(12) Patent Application Publication
(10) Pub. No.: US 2020/0078971 A1
(43) Pub. Date: Mar. 12, 2020

(54) SLICED PRODUCE CADDY

(71) Applicant: Prince Castle LLC, Carol Stream, IL (US)

(72) Inventors: Caitlin Sweeney, Evanston, IL (US); Rebecca Kasner, Shaumburg, IL (US); Richard Bauer, Palatine, IL (US); Jeremy Falkos, Batavia, IL (US)

(73) Assignee: Prince Castle LLC, Carol Stream, IL (US)

(21) Appl. No.: 16/567,833

(22) Filed: Sep. 11, 2019

Related U.S. Application Data
(60) Provisional application No. 62/729,693, filed on Sep. 11, 2018.

(51) Int. Cl. B26D 1/03; B26D 7/06; B26D 7/22

(52) U.S. Cl. CPC B26D 1/03; B26D 7/2614; B26D 7/225; B26D 7/0608

(57) ABSTRACT

A produce caddy and produce slicing system including a produce caddy may be used in to facilitate simultaneous slicing of multiple pieces of produce. The produce caddy may include a plurality of interconnected produce receiving assemblies. Each produce receiving assembly may be defined by at least two side walls. A bottom connects the at least two side walls of each produce receiving assembly. The produce receiving assembly may be interconnected at the side walls between adjacent produce receiving assemblies.

### CROSS-REFERENCE TO RELATED APPLICATION

The present application claims priority of U.S. Provisional Patent Application No. 62/729,693, filed on Sep. 11, 2018, the contents of which are hereby incorporated by reference in its entirety.

### BACKGROUND

Restaurants and food service providers often slice produce or other food products for customers or they use sliced produce or other food products as part of their menu items. Sliced produce as used herein may refer to fruits and/or vegetables, however, other types of food, including meat, cheese, eggs, or bread may also be sliced in accordance with the examples as disclosed herein.

Produce slicing is typically a manually performed task due to the aforementioned desire for consistency. As slicing necessarily requires some form of blade or cutting surface, this naturally involves a desire to seek solutions to improve safety for food preparation workers. Currently available slicing solutions have exposed blade sets which can present a risk to users during set up and operation. Currently available slicing solutions are limited to slicing a single piece of produce at a time.

Areas that are designated for food preparation often have limited space. With currently available slicing solutions, separate devices are used with each device configured to slice different produce. The need to store and maintain multiple devices adds further expense and use of already limited food preparation space. Solutions further require flexibility in the use and operation. While many available slicers may speed up the process of slicing produce, these slicers do little or nothing to manage the collection of the produce once it is sliced. Typically, the sliced produce is left in a pile on a kitchen counter, or possibly collected in a container or bowl. However, in some food preparation settings, it is desirable to maintain the produce in a sliced, but otherwise whole condition, for example for portioning use or control. In another example, the use of a whole piece of produce in a sliced condition may be desired.

### BRIEF DISCLOSURE

A produce caddy may be used in conjunction with a produce slicer configured to simultaneously slice multiple pieces of produce. The produce caddy may include a plurality of interconnected produce receiving assemblies. Each produce receiving area may be defined by at least two side walls. A bottom connects the at least two side walls of each produce receiving area. The produce receiving assemblies may be interconnected at the side walls between adjacent produce receiving assemblies.

The produce caddy may further include engagement structures connected to the tops of the side walls. The engagement structures may include at least one of a sliding interface, a hook, or a mounting pin. The engagement structures may include a pair of rails configured to be secured to the produce slicer. The rails may include resilient clips configured to secure the rails to the produce slicer. The side walls may be funnel walls interiorly angled from a top end to a bottom end secured to the bottom of the produce receiving area. Apertures may be included through the funnel walls. At least one end wall may be secured between two funnel walls to define two produce receiving assemblies between two funnel walls. The funnel walls may be configured to apply a compressive force against a sliced piece of produce received therein.

A produce slicing system may include a frame and a pusher head that includes a plurality of pushers. A blade assembly may include a blade set and a plurality of target areas in alignment with, each target area in alignment with a pusher of the plurality of pushers. A produce caddy includes a plurality of interconnected produce receiving assemblies. Each produce receiving area is defined by at least two side walls and a bottom connecting the at least two side walls. The produce receiving assemblies of the produce caddy are interconnected at the side walls between adjacent produce receiving assemblies. The produce caddy is positioned below the blade assembly with each produce receiving area of the plurality of produce receiving assemblies in alignment with one target area of the plurality of target areas.

The produce slicing system may further include the produce caddy physically connected to the frame to position the produce caddy below the blade assembly. The produce caddy may be physically connected to the blade assembly to position the produce caddy below the blade assembly. The blade assembly may further include a blade cover extending over at least a portion of the blade set. The blade cover may include a plurality of apertures therethrough. Each of the apertures may define a target area of the plurality of target areas of the blade set. The produce caddy may be physically connected to the blade cover. Each produce receiving area of produce caddy is held in alignment below a respective target area of the blade set. The blade cover may include a plurality of target rings extending away from the blade cover in a direction opposite from the blade set. The side walls may be funnel walls that are interiorly angled from a top end to a bottom end. The bottom ends of the funnel walls are secured to the bottom of the produce receiving area. Apertures may extend through the blade cover and engagement structures of the produce caddy releasably secure the produce caddy to the blade assembly through the apertures. Two mounting rails are configured to be secured to the frame. Engagement structures of the produce caddy releasably secure the produce caddy to the two mounting rails. The mounting rails include resilient clips configured to secure the mounting rails to the frame. A sliding interface between the engagement structures and the mounting rails releasably secure the produce caddy to the frame.

### BRIEF DESCRIPTION OF THE DRAWINGS

FIG. 1 depicts an example of a produce slicer.

FIG. 2 is a perspective view of an example of a sliced produce caddy.

FIG. 3 is a front view of an example of the sliced produce caddy.

FIGS. 4A and 4B depict perspective views of an example of a sliced produce caddy and a registration rail.

FIG. 5 depicts an example of a sliced produce caddy connected to a slicer frame base.

FIG. 6 is a perspective view of an example of a sliced produce caddy with alignment hooks.

FIG. 7 is a perspective view of an example of a sliced produce caddy with alignment pins.

FIG. 8 is a bottom view of a blade assembly.

FIG. 9 is a top view of a sliced produce caddy connected to the blade assembly.

### DETAILED DESCRIPTION

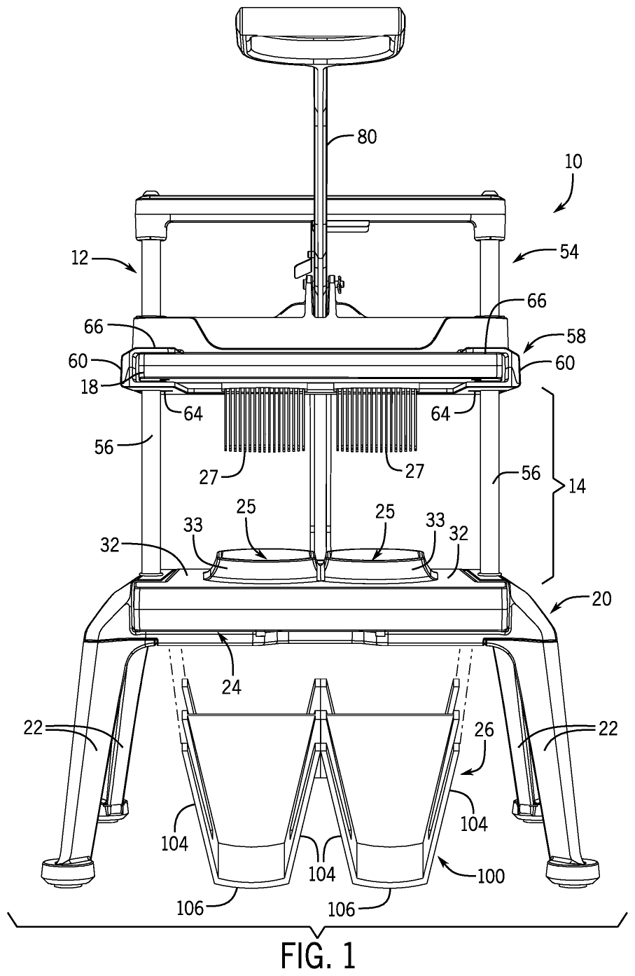

FIG. 1 depicts an example of a produce slicer 10. This and other produce slicers are described in further detail in U.S. Pat. No. 9,914,229, entitled “Produce Slicer,” which is hereby incorporated by reference in its entirety. The produce slicer 10 may exemplarily be configured to slice multiple pieces of produce at the same time, for example, to slice four tomatoes simultaneously. The produce slicer 10 includes a frame 12. The frame 12 includes a frame base 20 which itself may include at least one leg 22. The frame base 20 may include four legs, each extending from a corner of the frame base 20. The frame base may be a cantilevered construction, for example with base plate (not depicted) forming the product receiving area and at least one leg extending from the base plate to support a support surface cantilevered over the base plate. Such a construction facilitates open access to the product receiving area exemplarily from the front and sides. The frame 12 is operable to receive removable blade cartridges 14 that include a blade assembly 16 and a pusher head 18, the removable blade cartridges 14 allow the produce slicer 10 to be configurable to slice different types of produce (e.g. tomatoes, onions, lettuce, cucumbers, potatoes) and/or different amounts (e.g. one to four items simultaneously).

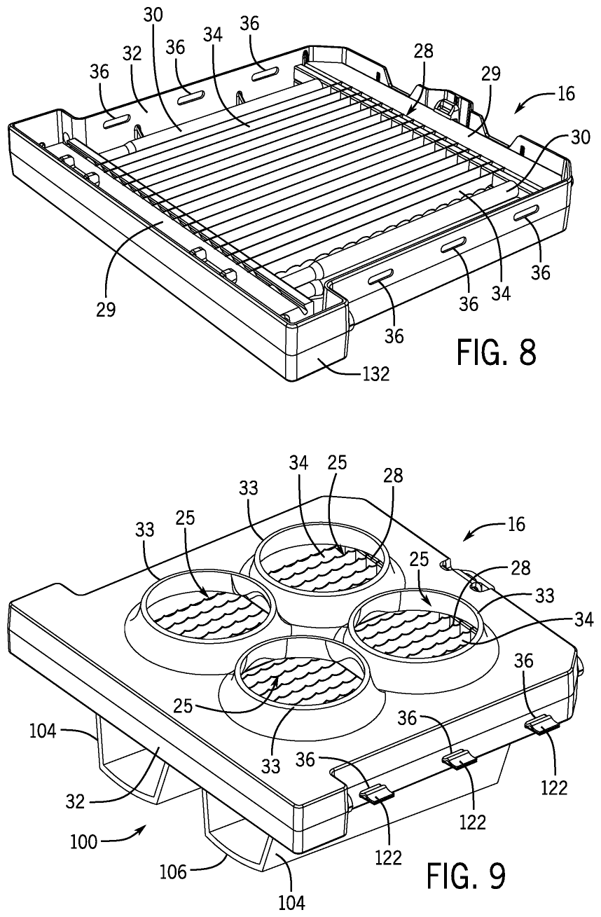

The frame base 20 is configured to receive, hold, and support the blade assembly 16. Support surfaces, alignment structures, and or locking mechanisms secure the blade assembly 16 to the frame base. The blade assembly 16 rests on a support shelf 24. The blade assembly 16 exemplarily includes blade sets 28 (see FIG. 8) and a blade cover 32. The blade cover 32 may define target areas 25, which themselves may be further defined by target rings 33.

The frame 12 further includes a pusher assembly 54 at least partially movably secured to the frame base 20. The pusher assembly 54 includes rails 56 which extend from the frame base 20. The pusher assembly 54 further includes a head receiver 58. The head receiver 58 is exemplarily slidingly secured to the rails 56 and is configured as described in further detail herein to receive a pusher head 18 of a blade cartridge 14. The head receiver 58 includes laterally opposed guide arms 60. The guide arms 60 include lower plates 64 and upper plates 66. The lower plates 64 and upper plates 66 of the guide arms 60 are exemplarily configured to slidingly receive a pusher head 18. The pusher head 18 is configured with one or more pushers 27 that correspond to a target area 25 of the blade assembly 16.

The produce to be sliced rests upon at least some of the blades of the blade assembly 16 and the pusher head 18 is actionable by an arm 80 to engage the produce and push it through the stationary blade assembly 16. The blades of the blade assembly 16 slice through the produce and the produce falls into a produce receiving area 26 located below the blade assembly 16 and defined by the frame base 20.

Typically a produce receiving container, for example, a food service pan is placed in the produce receiving area 26 to catch the sliced produce. The sliced produce is accumulated within the container. Slices of produce fall and stack on top of one another. In some applications and/or settings, it is desirable to retain the produce in a sliced, but otherwise whole, condition. In examples, each sliced piece of produce is maintained as separate and distinct from the other pieces of sliced produce. Despite slicing machines for example as described in U.S. Pat. No. 9,914,229, slicing is usually performed manually to achieve this outcome. Rather than receiving loose produce slices in a pan, a produce caddy 100 as described herein is positioned within the receiving area 26.

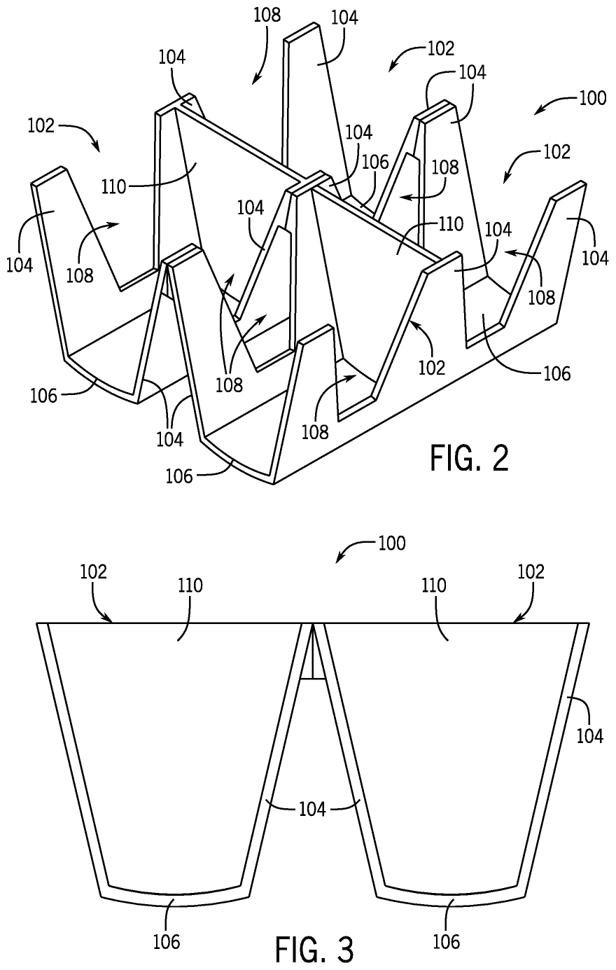

FIGS. 2 and 3 depict an example of a produce caddy 100. FIG. 2 is a perspective view of the produce caddy while FIG. 3 is a front view of the produce caddy 100. The produce caddy 100 exemplarily includes one or more receiving assemblies 102. In the example depicted, the produce caddy includes four receiving assemblies 102. The number of receiving assemblies in the produce caddy 100 may exemplarily be matched to the blade cartridge 14 in use with the slicer 10, to provide one receiving assembly 102 for each piece of produce sliced by an operation of the slicer 10. While the produce caddy 100 depicted in FIGS. 2 and 3 shows a unitary construction, it will be recognized that in other examples, each receiving assembly 102 is individually constructed and are connectable with other receiving assemblies 102 to modularly form the produce caddy 100.

The receiving assemblies 102 are exemplarily defined by funnel walls 104. The funnel walls 104 angle inwards towards a bottom 106 which is exemplarily in the shape of a depression. The bottom 106 is curved, while in other examples, the bottom 106 may have an angled or step-wise contour. The bottom 106 is thus exemplarily shaped to facilitate the shape of a portion of the sliced produce to be received. The funnel walls 104 open upwards in the direction of the blade cartridge and associated slicer 10. The funnel walls 104 direct the sliced produce, as a whole unit into engagement with the bottom 106, where the contour of the bottom has a general correspondence with at least a portion of the surface of the sliced produce. The funnel walls 104, locally to the bottom 106, are dimensioned sufficiently close so as to place a small inward retention force against the sliced produce to keep the slices of produce together. The gravitational force of the sliced produce falling from the blade cartridge helps to force the produce into engagement with the bottom 106.

The sliced produce caddy 100 is exemplarily depicted and described as configured to receive sliced tomatoes. However, it will be recognized that the sliced produce caddy 100 can be used for or otherwise configured to collect and maintain the general shape of the sliced produce of a wide variety of produce, including but not limited to: onions, cucumbers, pickles, carrots, potatoes, lemons, limes, apples, and others as would be recognized by a person of ordinary skill in the art. The funnel walls 104 are exemplarily dimensioned relative to the produce to be received within the caddy 100, and further dimensioned relative to the orientation of the produce relative to the slicer and the blade set. While most examples herein have been given with respect to linear slices, it will be recognized that blade assemblies for wedging or coring may similarly be used and that the sliced produce caddy 100 may also be used to receive wedged or cored produce as well.

The funnel walls 104 exemplarily include apertures 108 therein which are dimensioned to be narrower than an associated dimension of the sliced produce. The apertures 108 further extend from the top of the funnel walls 104 in a direction of the bottom 106 and terminate at a distance from the bottom 106 less than half of an average similar dimension of the sliced produce. In this configuration, a user of the sliced produce caddy 100 is able to manually apply a compressive force against the end slices of the sliced produce at at least a midpoint of such sliced produce in order to remove the sliced produce, as a whole unit from the receiving assembly 102. In an example, a user may use a thumb and forefinger to manually grip the sliced produce through the apertures 108 to remove the sliced produce.

Adjacent receiving assemblies 102 may be separated by an end wall 110. The end wall 110 may be unitarily constructed with the adjacent receiving assemblies 102. In another example, each receiving assembly 102 may include an end wall, and adjacent receiving assemblies may be connected respective end walls 110. In another example, with the interconnection of four receiving assemblies, adjacent end walls 110 are connected as well as adjacent funnel walls 104 are connected. The end walls 110 may also be angled in a direction towards the bottom 106 in a manner similar to that of the funnel walls 104.

In examples of use, the sliced produce caddy 100 is manually positioned within the produce receiving area 26 below the slicer 10. In examples of the sliced produce caddy 100 described in further detail herein, the sliced produce caddy 100 includes registration features or arms, that are configured to engage a portion of the slicer 10, for example, a portion of the slicer 10 to properly locate the produce caddy 100 relative to the slicer 10. The sliced produce caddy 100 can engage the frame 12, for example, the frame base 20. The sliced produce caddy 100 can engage the blade assembly 16, for example, the blade cover 32 or the blade sets. The sliced produce caddy 100 may be configured dependent upon the type and number of produce being sliced, and this, in turn, is determined by the blade cartridge 14 removably attached to the slicer 10, then the sliced produce caddy 100 is configured to engage with and register to a portion of the blade cartridge, for example, the blade assembly 16. In examples, this may include a lower portion of the blade assembly, including, but not limited to one or more blade set or the interior of blade cover 32.

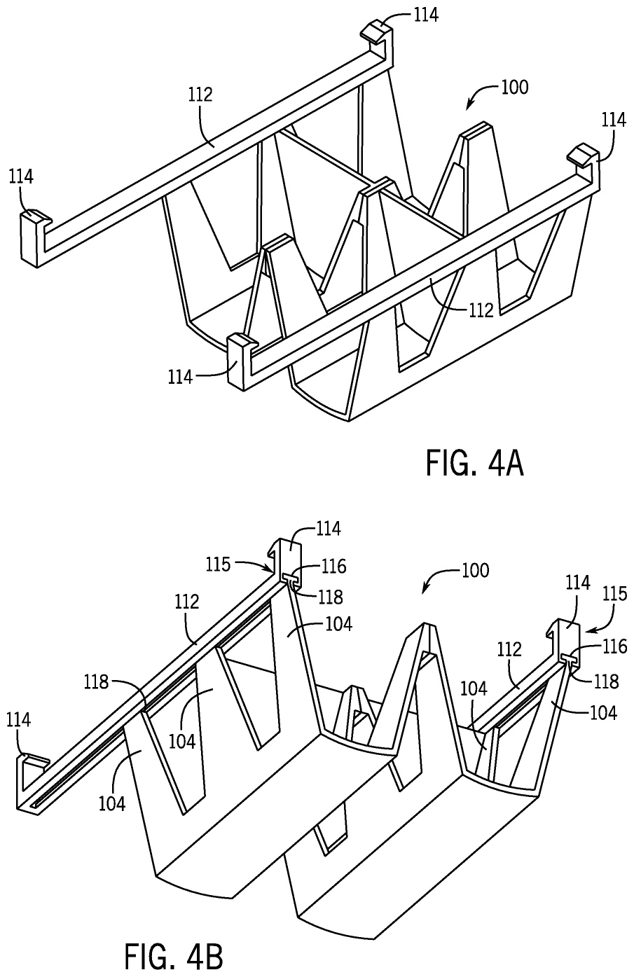

FIGS. 4A and 4B are front and rear perspective views of the sliced produce caddy 100 in combination engagement structures that operate to secure the sliced produce caddy 100 to the slicer 10. As shown in FIGS. 4A and 4B, the engagement structures may include a set of mounting rails 112 and a sliding interface 115. The mounting rails 112 may connect to the frame base 20 of the slicer, but may also be configured to connect to the blade assembly 16, blade cover 32, or a blade set of the blade cartridge of a slicer 10 (FIG. 1). The mounting rails 112 provide the interface with the slicer and the sliced produce caddy 100 slidingly engages the rails 112 to locate the sliced produce caddy 100 in position relative to the blade cartridge in order to receive the sliced produce as described above. The rails 112 exemplarily include resilient clips 114 that releasably engage a portion of the slicer 10 to provide an alignment/registration point or points to which the sliced produce caddy 100 can connect. While resilient clips 114 are depicted in FIGS. 4A and 4B, it will be recognized that other forms of securement, including, but not limited to fasteners for example screws or rivets. In still further examples, the rails 112 may be integrally constructed with the frame, blade cartridge, blade cover, or blade set of the slicer 10.

FIG. 4B depicts a sliding interface 115 that uses an exemplary combination of slots and rails. “T” slots 116 within the rails 112. The sliced produce caddy 100 exemplarily includes mating “T” ridges 118 at the tops of each of the funnel walls 104. It will be recognized that in other examples of sliding interfaces 115, the “T” slots 116 and the “T” ridges 118 may be reversed between the rails 112 and the funnel walls 104 while still remaining within the scope of the present disclosure. Receipt of the “T” ridges 118 into the “T” slots 116 enables sliding engagement between the sliced produce caddy 100 and the rails 112 to locate the sliced produce caddy 100 relative to the slicer 10.

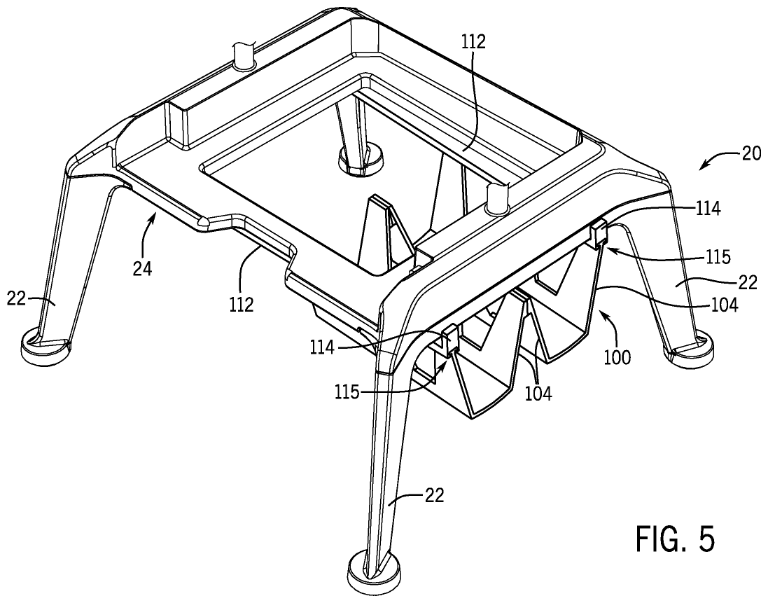

FIG. 5 is a partial perspective view of a frame 12 of a slicer 10 with the upper portion of the frame 12 removed so that only the frame base 20 is depicted. A sliced produce caddy 100 is secured to the frame base 20 by a pair of rails 112 that extend between portions of the frame base 20. The resilient clips 114 releasably connect the rails 112 to the frame base 20. As explained above with respect to FIGS. 4A and 4B, the rails provide a sliding interface 115 to secure the sliced produce caddy 100 to the frame base 20. When the sliced produce caddy is positioned as depicted, the sliced produce caddy held with each of the produce receiving assemblies 102 in alignment with a respective target area of the blade assembly (not depicted).

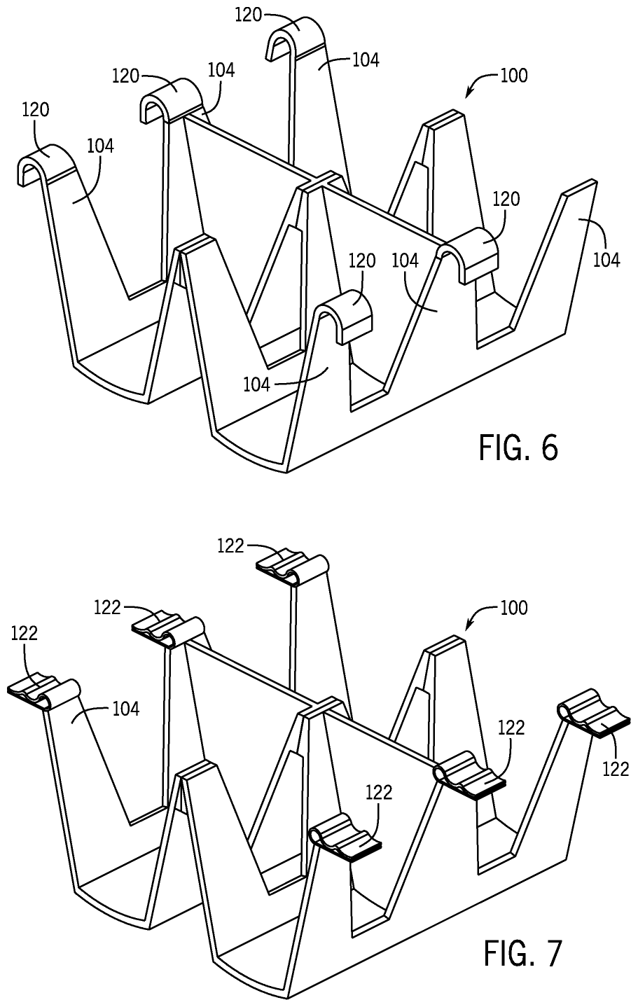

FIG. 6 depicts a further example of engagement structures, wherein the funnel walls 104 are provided with hooks 120 rather than “T” ridges as shown in FIG. 4B. The hooks 120 may facilitate connection of the sliced produce caddy 100 to the rails 112. The hooks 120 may be configured to directly connect to the frame of the slicer, for example to the legs of the slicer or to registration features extending into the produce receiving area from either the legs or the support surface of the frame. In other examples, the hooks 120 may releasably engage with a portion of the blade assembly. As previously noted, the sliced produce caddy 100 may be configured to receive a particular type of produce, for example, sliced tomatoes, sliced cucumbers, or sliced limes. Therefore, the blade assembly 16 and the produce caddy 100 may be configured to secure directly to one another. The hooks 120 may exemplarily removably engage with the frame bars 29, the tension rods 30, or the blade cover 32. Those components of the blade assembly are described in further detail with respect to FIG. 8.

FIG. 7 depicts still further examples of engagement structures on the sliced produce caddy 100. Pin mounts 122, secured to the top ends of the funnel walls 104 can resiliently deform to receive a rail 112, a registration feature as previously described, or a portion of the blade assembly 16. In still further examples, and as described in further detail with respect to FIGS. 8 and 9, the pin mounts 122 can be received into registration features in the blade assembly 16.

FIGS. 8 and 9 depict an example of a blade assembly 16. FIG. 8 is a bottom perspective view and shows an example of at least one blade set 28 secured within a blade cover 32 of the blade assembly 16. The at least one blade set 28 includes frame bars 29 held apart by tension rods 30. A plurality of blades 34 extend between the frame bars 29. As previously described above with respect to the engagement structures of the hooks 120 or the pin mounts 122, those engagement structures may be configured to receive a portion of rails 112, or portions of the blade assembly 16, for example, the frame bars 29 or tension rods 30. As shown in FIG. 8, the blade cover 32 may include a series of registration features in the form of engagement apertures 36 through which a hook 120 or pin mount 122 may extend. FIG. 9 exemplarily depicts pin mounts 122 extending through engagement apertures 36. While FIGS. 8 and 9 show registration features in the form of engagement apertures 36, it will be recognized that similar registration features may be provided as structures extending towards the interior of the blade assembly 16 from the blade cover 32.

FIG. 9 is a top perspective view of the blade assembly 16 with a produce caddy 100 secured thereto. As previously noted, the produce caddy 100 is secured to the blade assembly 16 by engagement of the pin mounts 122 into engagement apertures 36 in the blade cover 32. In examples, the produce caddy 100 may be connected to the blade assembly 16 and then the blade assembly secured to the frame 12 of the slicer 10. In another example of use, the blade assembly 16 may be secured to the frame 12 of the slicer 10 and then the produce caddy 100 secured to the blade assembly 16.

As can be seen in FIG. 9, the blade assembly defines a plurality of target areas 25 on the blades of the blade set 28 contained within the blade cover 32. The target areas 25 may be additionally defined by target rings 33. The connection of the produce caddy 100 to the blade assembly 16 thus aligns each of the produce receiving assemblies 102 of the produce caddy 100 with one of the target areas 25 of the blade assembly.

This written description uses examples to disclose the invention, including the best mode, and also to enable any person skilled in the art to make and use the invention. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A produce caddy for use in conjunction with a produce slicer configured to simultaneously slice multiple pieces of produce, the produce caddy comprising:
a plurality of interconnected produce receiving assemblies, each produce receiving area defined by:
at least two side walls; and
a bottom connecting the at least two side walls; and
wherein the produce receiving assemblies are interconnected at the side walls between adjacent produce receiving assemblies.

2. The produce caddy of claim 1, further comprising engagement structures connected to the tops of the side walls.

3. The produce caddy of claim 2, wherein the engagement structures comprise at least one of a sliding interface, a hook, or a mounting pin.

4. The produce caddy of claim 2, wherein the engagement structures comprise a pair of rails configured to be secured to the produce slicer.

5. The produce caddy of claim 4, wherein the rails comprise resilient clips configured to secure the rails to the produce slicer.

6. The produce caddy of claim 1, wherein the side walls are funnel walls interiorly angled from a top end to a bottom end secured to the bottom of the produce receiving area.

7. The produce caddy of claim 6, further comprising apertures through the funnel walls.

8. The produce caddy of claim 7, further comprising at least one end wall secured between two funnel walls to define two produce receiving assemblies between two funnel walls.

9. The produce caddy of claim 6, wherein the funnel walls are configured to apply a compressive force against a sliced piece of produce received therein.

10. A produce slicing system comprising:
a frame;
a pusher head comprising a plurality of pushers;
a blade assembly comprising a blade set and a plurality of target areas on the blade set, each target area of the plurality of target areas in alignment with a pusher of the plurality of pushers; and
a produce caddy comprising a plurality of interconnected produce receiving assemblies, each produce receiving area defined by at least two side walls and a bottom connecting the at least two side walls, wherein the produce receiving assemblies of the produce caddy are interconnected at the side walls between adjacent produce receiving assemblies and the produce caddy is positioned below the blade assembly with each produce receiving area of the plurality of produce receiving assemblies in alignment with one of a target area of the plurality of target areas.

11. The system of claim 10, wherein the produce caddy is physically connected to the frame to position the produce caddy below the blade assembly

12. The system of claim 11 further comprising two mounting rails configured to be secured to the produce slicer wherein engagement structures of the produce caddy releasably secure the produce caddy to the two mounting rails.

13. The system of claim 12, wherein the rails comprise resilient clips configured to secure the rails to the frame base of the produce slicer.

14. The system of claim 13 wherein a sliding interface between the side walls and the mounting rails releasably secures the produce caddy to the frame.

15. The system of claim 10, wherein the produce caddy is physically connected to the blade assembly to position the produce caddy below the blade assembly.

16. The system of claim 15, wherein the blade assembly further comprises a blade cover extending over at least a portion of the blade set, the blade cover having a plurality of apertures therethrough, each of the apertures defining a target area of the plurality of target areas on the blade set.

17. The system of claim 16, wherein the produce caddy is physically connected to the blade cover and wherein each produce receiving area of the produce caddy is held in alignment below a respective target area of the blade set.

18. The system of claim 17, wherein the blade cover comprises a plurality of target rings extending away from the blade cover in a direction opposite from the blade set.

19. The system of claim 17 further comprising apertures through the blade cover wherein engagement structures of the produce caddy releasably secures the produce caddy to the blade assembly through the apertures of the blade cover.

20. The system of claim 10, wherein the side walls are funnel walls interiorly angled from a top end to a bottom end, the bottom ends of the funnel walls secured to the bottom of the produce receiving area, the funnel walls comprising apertures extending through the funnel walls to the produce receiving area.
